(19) United States
(12) Patent Application Publication
(10) Pub. No.: US 2006/0059153 A1
(43) Pub. Date: Mar. 16, 2006

(54) Computer constructions of a lexical tree

(75) Inventor: Edmond Lassalle, Lannion (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: FRANCE TELECOM, Paris (FR)

(21) Appl. No.: 11/221,774

(22) Filed: Sep. 9, 2005

(30) Foreign Application Priority Data
Sep. 10, 2004 (FR) 0409607

(51) Int. Cl. G06F 17/30

(52) U.S. Cl. 707/7

(57) ABSTRACT

To reduce the memory space of the computer representation of a lexical tree and to find a word rapidly therein, the words are sorted in lexicographical order and the tree is then constructed by iteration. A prefix of the preceding and following words and a suffix of the following word are determined. If in the preceding word the length of a particular string, at the end of which a length from the root of the tree is at least equal to the length of the prefix, is greater than that of the prefix, the particular string is divided into first and second sub-strings. The suffix and the second sub-string that replaces the particular string are stored at first and second addresses in a son summit table relating to the first sub-string.

### RELATED APPLICATIONS

The present application is based on, and claims priority from, French Application Number 0409607, filed Sep. 10, 2004, the disclosure of which is hereby incorporated by reference herein in its entirety.

### FIELD OF THE INVENTION

The present invention relates to the computer construction of an arborescent data structure from a set of data. It relates more particularly to the construction of a lexical tree.

### BACKGROUND ART

The terminology employed for the computer construction of a tree in the present description is defined hereinafter.

A tree is a data structure represented by a graph made up of a plurality of summits S connected in pairs by arcs and complying with properties of strong connexity and non-cyclicity. By convention, the components of the tree are defined in a downward direction from the summit of the tree, called the root of the tree, to the extremities of the tree, called leaves or end summits. A summit of the tree having at least one descendent summit constitutes a node. A summit having no descendent summit constitutes a leaf. A node may be followed by more than two descendent summits.

A direct descendent summit of a node is called a son summit. The son summits situated the furthest to the left and the furthest to the right of the descendent son summits of a node are respectively called the left-hand son summit and the right-hand son summit.

A path in the tree is an ordered series of summits in the downward direction from the root R to an end summit of the path or to a leaf of the tree. If it is assumed that a tree is constructed from left to right, a left-hand path passes through all the nodes and the leaf situated the farthest to the left of the tree at all depth levels. A depth level in the tree is the number of consecutive characters associated with the arcs crossed by a path from the root, exclusive of the root itself.

To code a tree, each arc associated with a summit that terminates the arc in the downward direction of the tree is referenced by a label that contains an item of data from the set of data to be classified and is designated by an address constituting a pointer of the associated node. The label of the arc particularly associated with a leaf may include parameterized information and annotations useful for subsequent processing of the item of data, such as spelling correction in a word processing of the word that terminates the leaf.

The skeleton of a path is defined as a finite string concatenating the labels of the arcs constituting the path.

According to the patent application WO 03/073320 filed by the applicant, the computer representation of a tree having N summits is derived from a one-to-one relationship of the set [1, N] in itself and is used for searches from the root toward the leaves. Each item of data associated with a node of the tree is a character such as a letter of an alphabet and is pointed to by two values in a table stored in a memory, namely a value representative of a prefix rank of the node, and an address the value stored at which is representative of a postfix rank of the node. The prefix ranks of the nodes are ordered in accordance with a first total order relationship that is a combination of a descendent order relationship ordering a node relative to its descendents and a first-born order relationship ordering the son nodes of the same node. The postfix ranks of the nodes are ordered in accordance with a second total order relationship which is a combination of the order relationship which is the inverse of said descendent order relationship and said first-born order relationship.

However, this prior art form of representation is not that most suitable for a lexical tree, for the following main reasons. In a lexical tree, a path is the representation of the concatenation of the characters of a word from the lexicon. The prior art form of representation, like any prior art lexical representation, requires that a node relating to a given character have at least one son node relating to the next character after the given character in a word from the lexicon.

The order of the prefix ranks and the order of the postfix ranks do not distinguish the numbering of a node from that of a leaf. An arborescent analysis has essentially two objectives. On the one hand, the analysis determines the word from the dictionary corresponding to the search, that information being derived directly from the arborescent structure. On the other hand, the analysis adds to the information on the word, as a character string other linguistic, semantic, etc. information. The linguistic or semantic information is stored outside the arborescent structure in tables accessible via a numerical index. Each numerical index is determined by the leaf of the arborescence. An efficient way to access the tree is to make the numerical indices identical to the coding indices of the leaves of the arborescence. Coding by prefix order and postfix order leads to discontinuous numbering of the leaves, as indicated by the FIG. 3A example of the patent application WO 03/073320 cited above, in which the leaves occupy the indices 4, 5, 6, 9, 11, 12, 13, 14, 16, 18, 19, 20, 21, 22 and are marked out by numbering gaps 1, 2, 3, 7, 8, 10, 15, 17. The discontinuous numbering of the leaves represents a penalty on the processing of words, if only by leading to a loss of memory space through managing hollow tables. For example, the size of the indices may be multiplied by a factor of 7 or 8 in certain cases to no benefit.

An object of the invention is to reduce the memory space of the computer representation of a lexical tree and to find a word in the lexical tree faster than in trees constructed according to the prior art.

### SUMMARY OF THE INVENTION

Accordingly, a method for the computer construction of a tree representative of a set of words each made up of at least one character is characterized in that it comprises, after sorting words in an order defined by the characters, the following steps such that each word following a preceding word is stored in the form of concatenated character strings, each string except for the last one of the preceding word being associated with a table of addresses of son summits relating to strings of the tree succeeding said each string in the downward direction in the tree from the root thereof:
determining a prefix common to the preceding word and following word and deriving therefrom a suffix complementary to the prefix in the following word,
determining in the preceding word a string which is partially common to the prefix and at an end of which a length from the root along the path of the preceding word in the tree is at least equal to the length of the prefix,
dividing the determined string into a first sub-string and a second sub-string and storing the suffix and the second sub-string which replaces the determined string, respectively at a first address and a second address in a table of son summit relating to the first sub-string, if the length of the determined string is greater than that of the prefix, and
extending the determined string by the suffix and storing the suffix at a first address in a table of son summit relating to the determined string, if the lengths of the determined string and the prefix are equal.

The tree of the invention groups the path skeletons and can be explored in a single iteration on the prefix common to skeletons. For example, an exploration beginning with a skeleton beginning with “ab”, for example, means that the same analysis need not be repeated for words beginning with that string, such as abandon, abbey and above. If a node has at least two son summits, the choice of one of the son summits for continuing the analysis corresponds to a reduction of the search space. If the node has only one son summit, there is no reduction of the set of path skeletons to be analyzed. Only the label of the arc linking this summit to its descendent has the useful property. Explicit coding of the summit in question as a tree member is therefore not necessary. Implicit coding using the label as the only coding information is more efficient, as much from the use of memory space point of view as from the algorithm performance point of view.

The method of the invention constructs a representation of the lexical tree that satisfies the algorithm constraints referred to by allowing separation of the search guidance function and the search space reduction function.

Noting that the guidance function is based on identification of character strings whereas the search space reduction function is based on the arborescent structure, the invention constructs a tree in which each summit is advantageously represented by a local arborescent structure, i.e. by a table of its descendent summits. For a leaf, the table is empty. For the search space reduction function to be effective at each summit, each summit of the tree is either a leaf or a node having at least two descendents, which excludes summits having only one descendent unless the latter is a leaf. Each summit is associated with a label in order to link it to the labels of the descendents of the summit and thus to explore paths descending the tree and reconstitute the skeleton of the path by concatenating said labels. Rather than corresponding to a single character, each label corresponds to a character string that is a sub-string of a word from the lexicon.

The invention also relates to an data processing system for constructing a tree representative of a set of words each made up of at least one character. It is characterized in that it comprises
means for sorting words in an order defined by the characters, and
so that each word following a preceding word is stored in the form of concatenated character strings, each string except for the last one of the preceding word being associated with a table of addresses of son summits relating to strings of the tree succeeding said each string in the downward direction in the tree from the root thereof:
means for determining a prefix common to the preceding word and following word and deriving therefrom a suffix complementary to the prefix in the following word,
means for determining in the preceding word a string which is partially common to the prefix and at an end of which a length from the root along the path of the preceding word in the tree is at least equal to the length of the prefix,
means for dividing the determined string into a first sub-string and a second sub-string and storing the suffix and the second sub-string which replaces the determined string, respectively at a first address and a second address in a table of son summit relating to the first sub-string, if the length of the determined string is greater than that of the prefix, and
means for extending the determined string by the suffix and storing the suffix at a first address in a table of son summit relating to the determined string, if the lengths of the determined string and the prefix are equal.

The invention further relates to a computer program on a computer medium including program instructions adapted to construct a tree representative of a set of words each consisting of at least one character. When it is loaded into and executed in a computer system, after sorting the words in an order defined by the characters, the program performs the steps set out hereinabove of the computer tree construction method of the invention.

### BRIEF DESCRIPTION OF THE DRAWINGS

Other features and advantages of the present invention will become more clearly apparent on reading the following description of preferred embodiments of the invention, given by way of nonlimiting example and with reference to the appended drawings, in which:

FIG. 1 is an algorithm for the computer construction of a data tree in accordance with the invention;

FIGS. 2 to 6 are diagrams of lexical trees in the process of construction as a result of execution of the FIG. 1 algorithm; and

FIG. 7 is an algorithm for access to a tree so constructed.

### DETAILED DESCRIPTION OF THE DRAWINGS

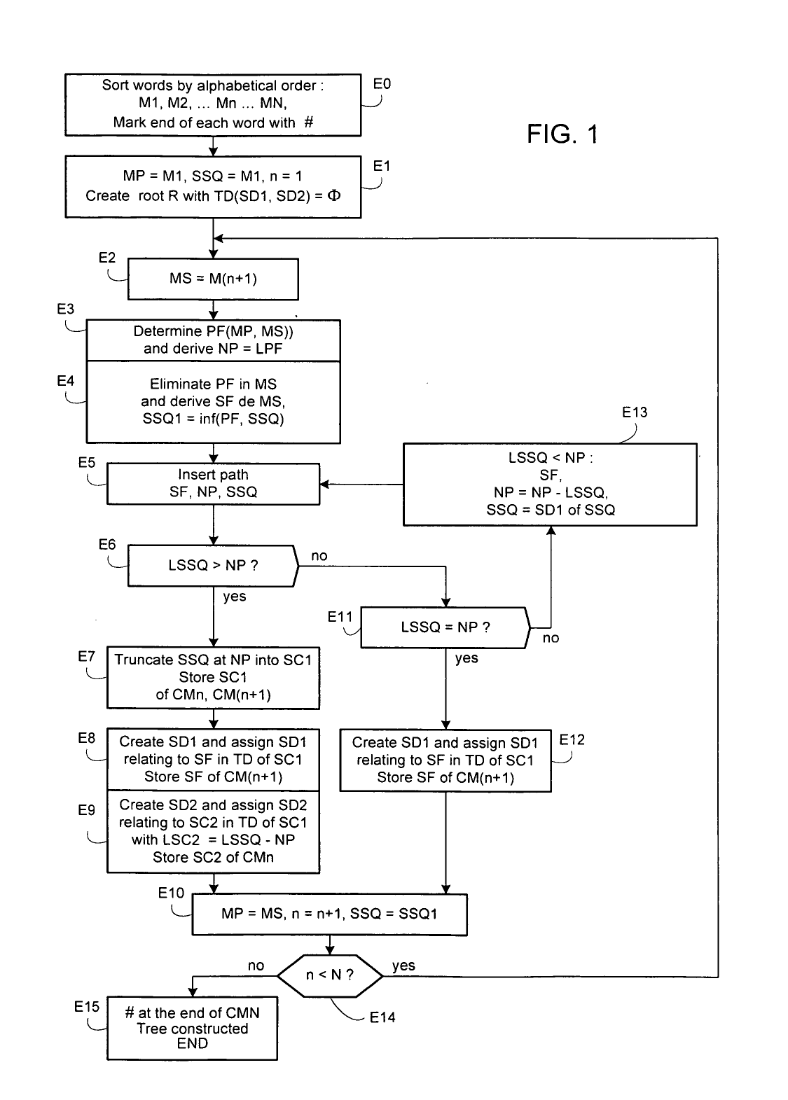

As shown in FIG. 1, the method of the invention of computer construction of a lexical tree comprises main steps E1 to E15. Those steps are for the most part implemented in the form of a computer program executed in a computer system, in particular a personal computer, and linked for example to a system for correcting lexical faults that may be integrated into a word processing system or a language study exercise system or a system for looking up words in response to a request in a search engine. The computer incorporates, or can access either locally or via a telecommunication network, a database as the ones used in the artificial intelligence field. The computer may be an electronic device or a good with telecommunication capability and personal to the user of the method, for example a communicating personal digital assistant PDA. It may equally be any other portable or non-portable domestic terminal, such as a video games console or an intelligent television receiver cooperating via an infrared link with a remote control including a display or an alphanumeric keyboard serving equally as a mouse.

Consequently, the invention applies equally to a computer program adapted to implement the invention, in particular a computer program on or in an information medium. The program may use any programming language and be in the form of source code, object code, or an intermediate code between source code and object code, for example in a partly compiled form, or in any other form desirable for implementing the method of the invention.

The information medium may be any entity or device capable of storing the program. For example, the medium may comprise storage means such as a read-only memory (ROM), for example a CD-ROM or a microelectronic circuit ROM, or magnetic storage means, for example a diskette (floppy disc) or a hard disc.

Furthermore, the information medium may be a transmissible medium such as an electrical or optical signal, which may be routed via an electrical or optical cable, by radio or by other means. The program of the invention may in particular be downloaded over an Internet Protocol network.

Alternatively, the information medium may be an integrated circuit into which the program is incorporated and which is adapted to execute or to be used in the execution of the method of the invention.

A tree representative of a set of words M1 to MN each made up of one or more characters C coded digitally is constructed in the computer by an iterative process using a correspondence between a word Mn and a path CMn to be constructed in the tree under construction.

Construction matches to each word Mn a unique path that links the root R of the tree to one of the leaves of the tree and whose skeleton is made up of consecutive arcs representative of character strings constituting data that when concatenated constitute the word Mn. This correspondence defines by construction an application Φ associating each subset En of words in the set of words to be processed with a sub-tree of the lexical tree.

Prior to a step E0, the words M1 to MN of the set of words are entered and stored in the database, a priori in no particular order, and are sorted in an order defined by the characters, in the present example in lexicographical (alphabetical) order, as in a lexicon, dictionary or directory. For a word Ma made up of I consecutive characters a₁a₂ . . . a_{I} and a word Mb made of J consecutive characters b₁b₂ . . . b_{J}, the word Ma is called the preceding word and precedes the word Mb which is called the following word if there exists an index k (k≦I and k≦J) such that a₁a₂ . . . aₖ and b₁b₂ . . . bₖ are identical character strings and aₖ₊₁ precedes bₖ₊₁ in the lexicographical order defined on the characters. Hereinafter, the word Mn is the word preceding the following word M(n+1) in the lexicon M1 to MN, with 1≦n<N.

The lexicon words being sorted in this way and ordered beforehand into a series of words M1 to MN, an increasing series of subsets of words E1⊂E2 . . . ⊂EN is defined by:
E₁={M1}
. . .
En=E(n−1)∪{Mn}.

The graph of the subsets E1 to EN by the application Φ defines a series of sub-trees Arbre1 to ArbreN and a relationship of inclusion between the sub-trees. This relationship of inclusion between the sub-trees is as follows: Arbren is included in Arbre(n+1) if Arbre(n+1) contains all the paths of Arbren.

To construct the lexical tree from the increasing series of subsets of words E1⊂E2 . . . ⊂En⊂E(n+1) . . . ⊂EN, the intersection of sub-trees Arbren and Arbre(n+1) is defined as the set of the summits and the arcs linking the summits common to the sub-trees Arbren and Arbre(n+1). The intersection of two sub-trees is a tree, which where applicable is empty.

The invention is concerned in particular with “degenerate” sub-trees, which are paths linking the root R to one of the leaves of the tree.

Constructing the lexical tree from the series E1⊂E2 . . . ⊂En consists in “adding” a new path CM(n+1) representative of the word M(n+1) to the tree under construction. The new path is determined by its skeleton defined by character strings constituting data which when concatenated constitute the word Mn of the lexicon. Initially, the skeleton of the first path CM1 is the word M1.

If M1 and M2 are two words from the lexicon, the intersection of the path CMn and the path CM(n+1) is equal to the prefix path CPF(CMn, CM(n+1)).

According to the above definitions, a₁a₂ . . . aₖ is the prefix common to the preceding word Ma=a₁a₂ . . . aₖ . . . a_{I} and the following word Mb=b₁b₂ . . . bₖ . . . b_{J}, has a length k and constitutes a sub-string of the words Ma and Mb.

For the following words classified in lexicographical order:
chaland
chalumeau
chameau
champêtre
   the prefixes are:
PF(chaland, chalumeau)=chal;
PF(chaland, chameau)=cha;
   and the suffixes are:
SF(chaland, chameau)=meau;
SF(chameau, chaland)=land.

It will also be noted that the word chaland precedes the word chameau which in turn precedes the word champêtre and that the prefix PF(chaland, champêtre) is a sub-string of the prefix PF(chameau, champêtre).

For the three words M1, M2 and M3 such that M1 precedes M2 and M2 precedes M3, the prefix PF(M1, M3) is a sub-string of the prefix PF(M2, M3), and the prefix PF(M1, M3) is identical to the prefix PR(PR (M1, M2), PF(M2, M3)).

If Arbren is the tree formed by joining together the paths CMi with 1≦i≦n, then the intersection of the Arbren and the path CM(n+1) is equal to the intersection of the paths CMn and CM(n+1). For any i≦n, the word Mi precedes the word Mn that precedes the word M(n+1).

Consequently, the intersection of the paths CMi and CM(n+1) equal to the prefix path CPF(Mi, M(n+1)) is contained in the intersection of the paths CMn and CM(n+1) since the prefix PF(Mi, M(n+1)) is a sub-string of the prefix PF(Mn, M(n+1)) according to the preceding property between three word prefixes.

The set of summits belonging to the path CM(n+1) and not belonging to Arbren is equal to the set of summits belonging to the path CM(n+1) and not belonging to the path CMn. Moreover, these summits constitute a sub-path whose skeleton is equal to the suffix SF(CMn, CM(n+1)).

The construction of the lexical tree includes the main steps E0 to E15, as shown in FIG. 1.

Prior to the step E0, the words M1 to MN are entered, digitally coded character by character, and stored, a priori in no particular order, in the database of the computer and are sorted into an order defined by the characters, in the present example in lexicographical order, as already stated.

The next step E1, prior to iteration over the paths between the steps E2 and E14, initializes various variables in registers of the computer, like a preceding word MP made identical to the first word M1 of the lexicon constituting the ordered set of words, a sliding variable character string SSQ for tree skeleton summit made identical to the first word M1 and constituting the essential element in a label corresponding to an arc sliding from node to node along the portion common to a preceding path CMn and to the path CM(n+1) following the preceding path CMn and relating to the next word M(n+1) in the ordered set, and a path/word index n set to 1, with 1≦n<N. The construction method also uses other registers for variables SD1, SD2, PF, NP, SF and SSQ1 defined hereinafter.

It must be remembered that each summit S of the tree to be constructed is the (lower) end of an oriented arc of the tree preceding said summit and associated with a label including a respective character string, such as a string SSQ, having one or more characters and obtained from the minimum subdivision of a word during the construction of the tree in accordance with the invention. The label is designated by an address SD constituting a pointer of the associated summit. The path from the root of the tree representative of a word in the tree is addressable by a set of pointers designating respective labels including the consecutive character strings constituting the word. As the tree is explored, descending a path therein toward a leaf, each summit called as a node is associated with a table TD of address SD designating one or more descendent sonsummits, in order to pass from one character string to the next along the path. Hereinafter, a label is not distinguished from the character string that it contains, although the label can contain other elements relating in particular to properties of the character string and to parameters and annotations useful for subsequent processing of the character string as data.

The step E1 also creates the root R of the tree and initializes a table of descendent summits TD(SD1, SD2) that is empty for the root. The table is an address stack so that the first summit designated by the address SD1 and which was the last to be stored in the table is to the right of the second summit designated by the address SD2 and stored after the summit SD1. The table TD is initially empty because it is assumed that all the nodes at the ends of the first arcs of the tree originating at the root R are never sons and that these first arcs contain the root.

Briefly, to construct the lexical tree iteratively by enriching the lexicon with the word M(n+1), the path CMn is added directly to the next path CM(n+1). This addition of paths consists primarily in determining the prefix common to the words Mn and M(n+1) and to lengthening the skeleton sub-path CPF(CMn, CM(n+1)) by the sub-path having the skeleton SF(Mn, M(n+1)). The lexical tree is constructed directly by the skeleton tree made up of the paths, without recourse to any intermediate representation. When a word is added to the lexicon, a node at the end of the prefix PF(Mn, M(n+1)) is added to the two son summits of the node, or a son summit is added after a summit or the root. The construction of the tree is based on an iterative function between the steps E2 and E14 that invokes a suffix determination function in the steps E3 and E4 and then a recursive path insertion function in the steps E5 to E10.

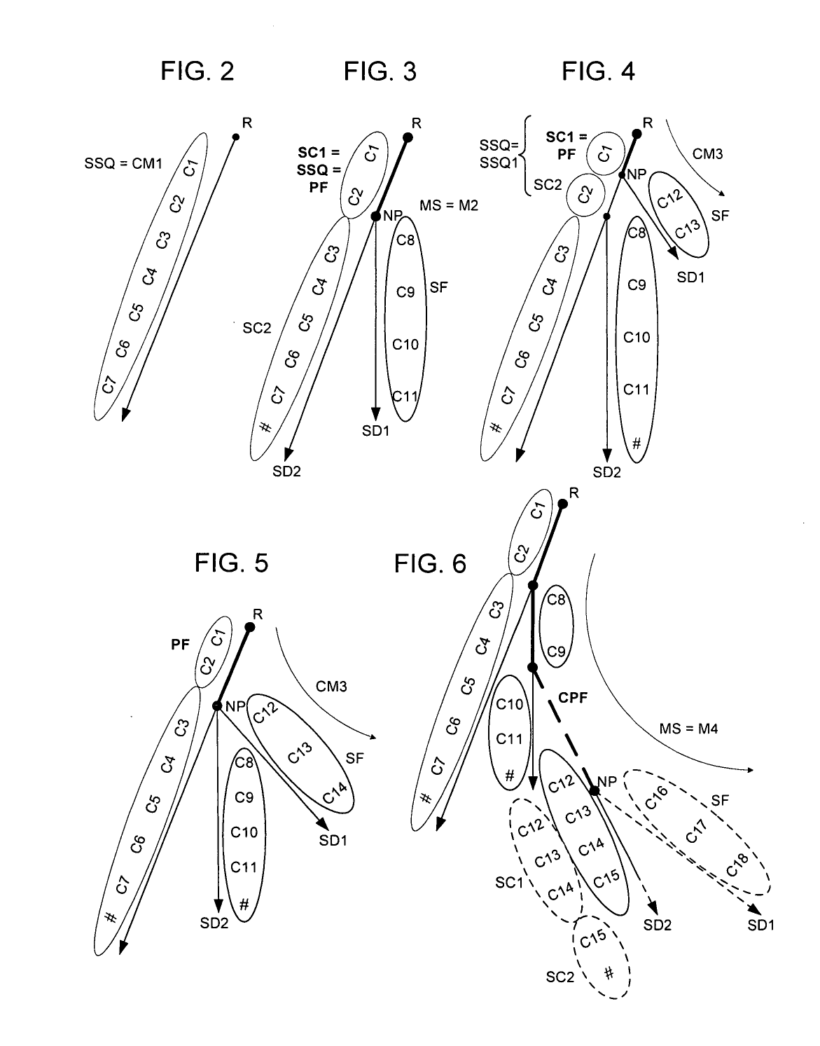

At the beginning of the iteration of the path in the step E2, a register for the next word MS=M(n+1) is filled with the word M(n+1) following the preceding word Mn. Accordingly, at the beginning of the first word iteration, the first word M1 from the lexicon constitutes a sliding character string SSQ for tree skeleton summit and is compared to the word M2. As shown in FIG. 2, the word M1 is made up of seven characters C1, C2, C3, C4, C5, C6 and C7, for example, constituting a character string whose address is included in the table of descendents TD associated with the root R.

The next two steps E3 and E4 determine a suffix SF of the next word M(n+1) constituting a leaf of the sub-tree Arbre(n+1) of the tree under construction.

The step E3 compares the preceding word MP=Mn with the next word MS=M(n+1) and determines the prefix PF(Mn, M(n+1)) common to the preceding word MP and to the next word MS and the length LPF of the prefix path CPF (CMn, CM(n+1)) expressed as a number of character. The length LPF of the prefix path is stored in a register of depth level NP of the end of the prefix path relative to the origin of the sliding character string SSQ that slides over the preceding path CMn as and when the depth level is reduced, as will emerge in the iteration loop step E13.

The step E4 eliminates the prefix PF in the next word MS in order to derive therefrom a suffix of the next word, that is to say, according to the above definitions, a suffix bₖ₊₁ . . . b_{J} of the word Mb. As shown in FIG. 3, the suffix SF(C8, C9, C10, C11) of a next word MS=MS(C1, C2, C8, C9, C10, C11) relative to a preceding word MP=M1(C1, C2, C3, C4, C5, C6, C7) is the termination that gives the next word MS again when that termination is concatenated with the common prefix PF(C1, C2). The step E4 stores the smaller of the strings PF and SSQ as the first character string SSQ1=inf(PF, SSQ) of the next path, which will become a preceding path in the next path iteration, as indicated in the step E10.

In the FIG. 2 example of the first path iteration, the variable string SSQ is M1 and the first character string SSQ1 is PF.

The subsequent steps E5 to E10 relate to a program for inserting the path representative of the next word MS=(n+1) by dividing the sliding character string SSQ of the preceding path CMn whose beginning is common to the prefix path CPF, into first and second character sub-strings SC1 and SC2 of the preceding path MP. The first sub-string SC1 constitutes a last character string of the prefix path CPF succeeding the last node common to the paths MP and MS. The second sub-string SC2 of the preceding path CMn may constitute a leaf of the tree or be empty.

The step E5 groups the registers containing the variables SF, NP and SSQ used in the subsequent steps. The length LSSQ of the sliding string SSQ is determined so that it can be compared to the depth level NP that, in the step E3, initially indicates the length of the prefix path CPF, i.e. the depth level of the end of the prefix relative to the root R, as indicated in steps E6 and E11.

In step E6, if the length LSSQ of the sliding character string SSQ is greater than the depth level NP, the steps E7, E8 and E9 are executed.

The character string SSQ of the preceding path CMn is divided into first and second character sub-strings SC1 and SC2 in the steps E7 and E9.

The first sub-string SC1 is derived by truncation of the preceding word MP at the depth level NP. It constitutes a final character string of the prefix path CPF following on from the last node common to the paths CMn and CM(n+1) and corresponds to a truncation of the string SSQ at the level NP in the step E7. The sub-string SC1 is stored as a character string both for the preceding path CMn and for the next path CM(n+1) and is therefore designated by a first-descendent-son address of the last node of the path CMn preceding the depth level NP.

The first sub-string SC1 is not distinguished from the prefix PF(MP, MS) if the prefix path extends only over the first string of the preceding path CMn situated at the root R. FIG. 4 shows this configuration in which the path of a third word MS=M3(C1, C12, C13) must be introduced into the tree after the word MP=M2(C1, C2, C8, C9, C10, C11) having the path CM2((C1, C2), C8, C9, C10, C11)), the character C12 following on from the character C2 in character order. The character string (C12, C13) following on from the prefix path CPF(C1) is stored as the suffix SF of the next word path CM3 in the step E7. The character string SSQ(C1, C2)=SSQ1 of the preceding path CM2 longer than the prefix path CPF(C1) is divided into character sub-strings SC1(C1) and SC2(C2) in the steps E7 and E9.

In a variant of the above example, the third word is a word MS=M3(C12, C13) whose path originates directly at the root R of the tree, assuming that the character C12 follows on from the character C1 in the character order. In this variant, the prefix between the words MP=M2(C1, C2, C8, C9, C10, C11) and MS=M3(C12, C13) is empty, and the first sub-string SC1 is empty and “not distinguished from” the root.

A first son summit SD1 is created and assigned to the end of the suffix SF that is stored as the provisional last string of the next word MS=M(n+1) in the step E8. The address SD1 of the sub-string SC2 is therefore relative to a first son summit of the summit relating to the first sub-string SC1 and is stored in the table TD associated with the sub-string SC1.

In the step E9, a second summit SD2 is created and assigned to the end of the second character sub-string SC2 whose length LSC2 is the difference between the lengths LSSQ and NP. The second sub-string SC2 is therefore the complement of the prefix path CPF in said sliding character string SSQ at the end of the preceding path CMn. The sub-string SC2 replaces the string SSQ and therefore inherits from the son summits table TD of the string SSQ. The address SD2 is stored in the table TD associated with the first sub-string SC1 to designate the summit of the sub-string SC2 that is a son of the node relating to the sub-string SC1. The summits SD1 and SD2 are therefore stored as first and second sons of the summit relating to the first sub-string SC1, the strings SF and SC1 following on from the string SC1 in the paths CMn and CM(n+1), respectively.

The second sub-string SC2 is a leaf of the tree and stored as the last string of the preceding path CMn if the summit SD2 is not already a node of the tree and is therefore not associated with at least two son summits. In graphical terms, the sub-string SC2 is now situated laterally to the left of the suffix string SF and cannot be relevant to the subsequent construction of the sub-tree Arbre(n+2) of the lexical tree associated with the word M(n+2) of which at least one character follows on from the character of the same rank in the prefix, over at most the length of the prefix path CPF from the root R. FIG. 6 shows this configuration in which the path of a third word MS=M3(C1, C2, C8, C9, C12, C13, C14, C15) must be introduced into the tree after the path CM2((C1, C2), (C8, C9, C10, C11)) of the word MP=M2(C1, C2, C8, C9, C10, C11), the character C12 following the character C10 in character order. The character string (C10, C11) following the prefix path CPF((C1, C2), (C8, C9)) in the preceding path CM2 is stored as the last string SC2 of the preceding path CMn relating to the second summit SD2 for the table TD associated with the string (C8, C9) and therefore as a leaf of the tree. A termination character # of the tree is added to the end of the string SC2(C10, C11) to mark the leaf and to identify it easily in the constructed tree if an access from the string SC2 to the tree has no son summit.

In the above FIG. 6 example, after the steps E7 to E9, the path CM2 representative of the preceding word MP=M2(C1, C2, C8, C9, C10, C11) is explored from the root R in accordance with three items of data respectively identical to the successive strings (C1, C2), (CB, C9) and (C10, C11, #) of which the first two are stored in association with descendent tables TD at two son summit addresses, which occupies less memory space in the computer than seven character memory locations respectively containing the characters C1, C2, C8, C9, C10, C11 and # and each associated with a son address, except for the characters C2 and C8 which are associated with two son addresses. The last string SF(C12, C13, C14, C15) of the next path CM3 is stored as a unique addressable data item SD1 by the table TD associated with the string SC1 (C8, C9) of the data structure consisting of the tree and is also more economic in memory terms than if the four characters constituting the string SC1, the first three of which have a son summit address, were to be stored separately in four respective separate memory locations.

After the steps E7 to E9, the step E10 transfers the content of the next word register MS into the preceding word register MS, increments by one unit the path index/word n register and transfers the content of the first next character string SSQ1 register into the preceding word sliding string SSQ register.

Returning to the step E6, and then to the step E11, if the length LSSQ of the sliding character string SSQ is equal to the depth level NP, a step E12 similar to the step E7 is executed before the step E10.

FIG. 5 shows this situation of equal lengths, for example. The prefix path CPF(C1, C2) common to the preceding path CMn=M2((C1, C2), (C8, C9, C10, C11)) and to the next path CM(n+1)=M3((C1, C2), (C12, C13, C14)), the character C12 following the character C8 in the character order, is as long as the first character string SSQ(C1, C2)=SSQ1 of the preceding path CM2. A summit SD1 is created and assigned to the end of the suffix SF(C12, C13, C14) that is stored as a provisional last string of the next word MS=M3 relative to a node as first son SD1 in the table TD of the node relative to the prefix string (C1, C2) in the step E12. In this latter table TD, the son summits relating to the strings (C8, C9, C10, C11) and (C3, C4, C5, C6, C7), that are initially first and second sons, become second and third sons. No string in the preceding path CM2 is broken. The last character string (C8, C9, C10, C11) of the preceding path CM2 is permanently stored as a leaf of the tree and marked by a termination character #, as this last string has no son summit.

If, in the steps E6 and E11, the length LSSQ of the sliding character string SSQ is less than the depth level NP, the step E13 is executed, followed by the step E5, to descend one node along the path of the next word M(n+1). More generally, the recursive function for inserting the path CM(n+1) representative of the next word MS=M(n+1), comprising in particular the steps E5 and E6/E11, is executed as many times as the number of nodes in the prefix path CPF(CMn, CM(n+1)), including the root, of the path CMn of the preceding word MP=Mn in order to slide the variable character string SSQ of length LSSQ from arc to arc and thus from string to string along the preceding path CMn as far as the last string common to the latter and to the prefix path CPF. This latter common string contains a terminal portion of the prefix and is divided by applying the steps E7 to E9 or lengthened by the suffix SF of the next path CM(n+1) by applying the step E12.

The sliding of the string SSQ is expressed in the step E13 by reducing the depth level NP to NP−LSSQ in order to shorten fictionally the portion of the preceding path CMn remaining to be explored along the prefix path CPF(CMn, CM(n+1)) and by overwriting the sliding character string SSQ in the sliding character string register with the string linked to the first son summit SD1 of the summit linked to the sliding character string in the preceding path CMn, i.e. in graphical terms the summit the farthest to the right under the sliding character string SSQ in the sub-tree Arbren of the tree under construction.

The iteration of the step E13 in the program for insertion of the path representative of the next word is shown in dashed outline by way of example in FIG. 6, although the sub-trees and the tree are not displayed on the screen of the computer. According to FIG. 6, the construction of the tree by the computer, and therefore dynamically without any intervention of the computer user, relates to four successive words M1(C1, C2, C3, C4, C5, C6, C7), M2(C1, C2, C8, C9, C10, C11), M3(C1, C2, C8, C9, C12, C13, C14, C15) and M4(C1, C2, C8, C9, C12, C13, C14, C16, C17, C18), assuming that the character C8 follows the character C3, the character C12 follows the character C10 and the character C16 follows the character C15 in the character order.

At the beginning of a first iteration for introducing the path of the next word MS=M4 along the preceding path CMn=CM3((C1, C2), (C8, C9), (C12, C13, C14, C15)), the sliding character string SSQ is identical to the first string SSQ1(C1, C2) of the preceding path CMn of length LSSQ=2 and is shorter than the depth level NP equal to the length of the prefix PF(MP, MS)=PF(M3, M4)=(C1, C2, C8, C9, C12, C13, C14). The step E13 is executed to reduce the depth level from NP=7 to NP−LSSQ=7−2=5 and to replace the sliding character string SSQ with the second string (C8, C9) of the preceding word, as string associated with the first son summit of the table TD relating to the underlying string (C1, C2). Then, during a second iteration of the step E5, the sliding character string SSQ(C8, C9) of length LSSQ=2 is even shorter than the depth level NP=5 corresponding to the terminal string with five characters C8, C9, C12, C13 and C14 of the shortened prefix path. The step E13 again reduces the depth level from NP=5 to NP−LSSQ=5−2=3 and replaces the sliding character string SSQ with the third string (C12, C13, C14, C15) of the preceding path CMn as string relating to the first son of the table TD associated with the underlying string (C8, C9). In the step E6, during a third iteration of the step E5, the sliding character string SSQ(C12, C13, C14, C15) is then longer than the depth level NP=3 corresponding to three terminal characters C12, C13 and C14 of the prefix path CPF(CMn, CM(n+1))=CPF(CM3, CM4), which leads to execution of the steps E7 to E9. These last three steps
divide the last character string SSQ(C12, C13, C14, C15) of the preceding word M3 into first and second character sub-strings SC1(C12, C13, C14) and SC2(C15),
truncate the last character string SSQ(C12, C13, C14, C15) at the depth level NP=3 into the first sub-string SC1(C12, C13, C14) that is stored as the third (data item) string of the paths CM3 and CM4 relating to a first son summit in the table TD associated with the strings (C8, C9),
create and assign a node SD1 to the end of the suffix SF(C16, C17, C18) that is stored as the last provisional string of the next word M4 and as the first son summit SD1 in the table TD of the summit relating to the sub-string SC1 (C12, C13, C14), and
create and assign a summit SD2 to the end of the second character sub-string SC2(C15) that is stored with a termination character # as a leaf of the tree and as a fourth (data item) string of the path CM3 relating to a second son summit SD2 in the table TD of the summit relating to the sub-string (C12, C13, C14).

Finally, after the step E10, following on from the steps E7 to E9 or from the step E12, and for as long as the path/word n index is less than N, the steps E2 to E13 are executed for the path CMn of each word of the set of words M1 to MN, as indicated in the step E14. After the introduction of the path of the last word MN into the tree, a termination character # is inserted at the end of the path CMN of the word MN and the computer construction of the tree is terminated, as indicated in the step E15. Each character string in the tree between two nodes, or between the root and a node, is associated with a descendent table including the list of the addresses SD of the next strings relating to the son nodes so as to descend in the tree. The tree is therefore organized, in computer terms, as a directory from the root R with a hierarchy of files including the character strings divided up by the construction of the tree.

A lexical access from a word to be analyzed MA consists in exploring the tree from the root R toward the leaves of the tree in order to determine progressively a path from the root toward one of the leaves of the tree, the skeleton of which concatenates character strings of the word MA to be analyzed. The descent of the tree continues for as long as a node relates to a string included in the word MA.

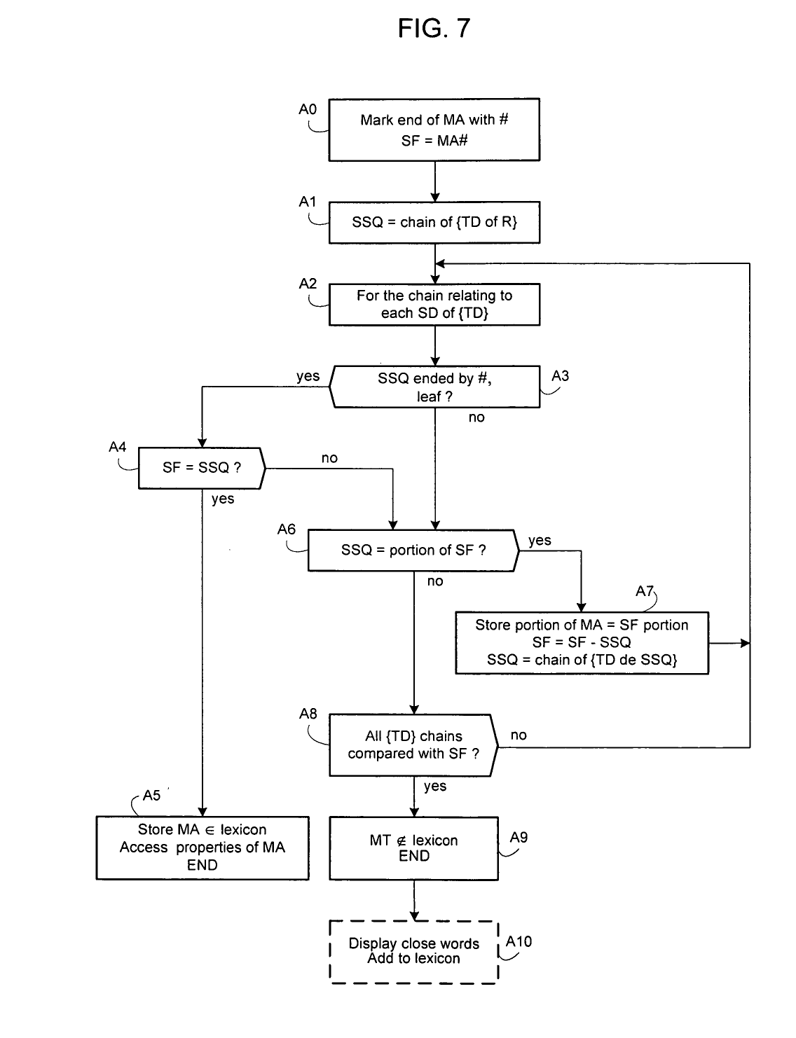

Lexical access based on a skeleton tree includes main steps A0 to A9 in the access algorithm shown in FIG. 7. It can be divided into two functions. The first function is recursive in steps A3 to A8 and filters all the descendents of a node, and therefore determines therefrom the descendent node SD whose label corresponds to a portion of the word to be analyzed. Once the descendent node SD has been identified, in the steps A2 and A7, the second function resumes the analysis of the descendent node and identifies its own descendents in order to navigate the tree.

Initially, in the step A0, the end of the word MA to be analyzed and recognized is completed by a termination character #, and the word MA is written into a variable suffix register SF. In the initial step A1, a second register relating to a variable character string SSQ is initially filled with the character strings whose source is the root R of the lexical tree and thus a “descendent” of the root. This register therefore contains the addresses of the descendent table TD associated with the root and designating the first strings in the paths of the tree constructed in accordance with FIG. 1 and therefore in the same order as the ordered words M1 to MN, from the bottom toward the top of the stack constituting the table TD, i.e. in the order of the characters, in order to begin to compare the word MA to these first path strings, such as the string (C1, C2) in FIG. 6.

The step A2 begins the iteration of the comparison of the word MA to be analyzed with the character string SSQ relating to one of the summits SD of the table TD and originating at the root R, beginning for example with that which is the farthest to the left in the tree. Thus each iteration relates to the comparison of a character string of a path of the tree, rather than to only one character, which accelerates access to the tree.

In the next step A3, the last character of the path variable character string SSQ is immediately read to find out if this string is a leaf of the tree and consequently corresponds to a single-string path and thus to a word from the lexicon. If the string SSQ is a leaf, it is compared to the word SF=MA# in the step A4 and, if they are identical, the word MA is deemed to belong to the lexicon, for example, to access properties of strings of the word MA, as indicated in the step A5.

If the path variable character string SSQ is not a leaf in the step A3 or is different from the word SF=MA# in the step A4, the step A6 compares the variable string SSQ with a first portion of the word SF having the same number of characters as the variable string SSQ. If they are identical, the portion SSQ of the word SF is stored as a first string of the word MA, the word SF is truncated of the portion SSQ of the word SF, and the second register is filled with addresses from the table TD for the character strings that relate to descendent summits SD that are sons of the summit relating to the string SSQ that has just been stored as the first string of the word MA and are therefore considered as second strings in paths of the tree, in the step A7. The access algorithm then loops to the step A2 and begins the analysis of the second string of a first second descendent node.

If the variable string SSQ is different from the first portion of the word SF in the step A6, the access algorithm attempts an analysis of the first next “descendent” string of the root R read in the second register, as indicated by the stringing of the steps A6, A8 and A2, until it finds where applicable a first next “descendent” string of the root R identical to a first string of the word MA, as already explained for the step A7.

The steps A2 to A8 are iterated as many times as the word SF might have been divided into consecutive portions respectively identical to character strings composing a path of the tree.

If in the step A8 no string SSQ of the same hierarchical level is found that is identical to a corresponding portion of the same level in the word SF=MA# progressively shortened by execution of the step A7, the word MA is deemed not to belong to the lexicon, in the step A9. For example, as indicated to a possible subsequent step A10, a list of close words having first strings (portions) in common with the word MA found by executing the step A7 may be displayed and/or the word MA may be added to the lexicon using a path construction method based on the method of constructing the tree according to the invention.

If in the end, after a final execution of the steps A2, A3 and A4, the path variable character string SSQ is identical to a final portion of the word SF=MA#, the word MA belongs to the lexicon and is stored in the form divided into said portions found in this way and thus into character strings of a single path of the lexical tree, in the step A5.

1. A method for the computer construction of a tree representative of a set of words each made up of at least one character,
said method comprising, after sorting words in an order defined by the characters, the following steps such that each word following a preceding word is stored in the form of concatenated character strings, each string except for the last one of said preceding word being associated with a table of addresses of son summits relating to strings of the tree succeeding said each string in the downward direction in the tree from the root thereof:
determining a prefix common to said preceding word and following word and deriving therefrom a suffix complementary to said prefix in said following word,
determining in said preceding word a string which is partially common to said prefix and at an end of which a length from the root along the path of said preceding word in said tree is at least equal to the length of said prefix,
dividing the determined string into a first sub-string and a second sub-string and storing said suffix and said second sub-string which replaces said determined string, respectively at a first address and a second address in a table of son summit relating to the first sub-string, if the length of said determined string is greater than that of said prefix, and
extending said determined string by said suffix and storing said suffix at a first address in a table of son summit relating to said determined string, if the lengths of said determined string and said prefix are equal.

2. A method as claimed in claim 1, wherein the step of determining a string comprises, if the length of a first string in said preceding word is less than said length of said prefix, for each next string in the preceding word, iteratively reducing the length of the prefix by the length of said next string and comparing said length of said next string with the reduced length of said prefix, until a next string is found that is said determined string whose length is at least equal said length of said prefix.

3. The method as claimed in claim 1, wherein a termination character is added to the end of said second sub-string if the latter has no son summit.

4. A computer tree representative of a set of words each made up of at least one character, said computer tree being constructed, after sorting words in an order defined by the characters, according to the following steps such that each word following a preceding word is stored in the form of concatenated character strings, each string except for the last one of said preceding word being associated with a table of addresses of son summits relating to strings of the tree succeeding said each string in the downward direction in the tree from the root thereof:
determining a prefix common to said preceding word and following word and deriving therefrom a suffix complementary to said prefix in said following word,
determining in said preceding word a string which is partially common to said prefix and at an end of which a length from the root along the path of said preceding word in said tree is at least equal to the length of said prefix,
dividing the determined string into a first sub-string and a second sub-string and storing said suffix and said second sub-string which replaces said determined string, respectively at a first address and a second address in a table of son summit relating to the first sub-string, if the length of said determined string is greater than that of said prefix, and
extending said determined string by said suffix and storing said suffix at a first address in a table of son summit relating to said determined string, if the lengths of said determined string and said prefix are equal.

5. A system for computer constructing a tree representative of a set of words each made up of at least one character, comprising a processor arrangement for
(a) sorting words in an order defined by the characters, so that each word following a preceding word is stored in the form of concatenated character strings, each string except for the last one of said preceding word being associated with a table of addresses of son summits relating to strings of the tree succeeding said each string in the downward direction in the tree from the root thereof; (b) determining a prefix common to said preceding word and following word and deriving therefrom a suffix complementary to said prefix in said following word; (c) determining in said preceding word a string which is partially common to said prefix and at an end of which a length from the root along the path of said preceding word in said tree is at least equal to the length of said prefix; (d) dividing the determined string into a first sub-string and a second sub-string and storing said suffix and said second sub-string which replaces said determined string, respectively at a first address and a second address in a table of son summit relating to the first sub-string, if the length of said determined string is greater than that of said prefix; and (e) extending said determined string by said suffix and storing said suffix at a first address in a table of son summit relating to said determined string, if the lengths of said determined string and said prefix are equal.

6. A computer program on a computer readable medium or storage device including program instructions adapted to construct a tree representative of a set of words each made up of at least one character, said program when it is loaded into and executed in a computer system, after sorting the words in an order defined by the characters, performing the following steps such that each word following a preceding word is stored in the form of concatenated character strings, each string except for the last one of said preceding word being associated with a table of addresses of son summits relating to strings of the tree succeeding said each string in the downward direction in the tree from the root thereof:
determining a prefix common to said preceding word and following word and deriving therefrom a suffix complementary to said prefix in said following word,
determining in said preceding word a string which is partially common to said prefix and at an end of which a length from the root along the path of said preceding word in said tree is at least equal to the length of said prefix,
dividing the determined string into a first sub-string and a second sub-string and storing said suffix and said second sub-string which replaces said determined string, respectively at a first address and a second address in a table of son summit relating to the first sub-string, if the length of said determined string is greater than that of said prefix, and
extending said determined string by said suffix and storing said suffix at a first address in a table of son summit relating to said determined string, if the lengths of said determined string and said prefix are equal.
